(19) United States
(12) Patent Application Publication
(10) Pub. No.: US 2025/0203220 A1
(43) Pub. Date: Jun. 19, 2025

(54) MOTION-AWARE AUTOMATIC EXPOSURE CONTROL

(71) Applicant: Advanced Micro Devices, Inc., Santa Clara, CA (US)

(72) Inventor: Rastislav Lukac, Santa Clara, CA (US)

(73) Assignee: Advanced Micro Devices, Inc., Santa Clara, CA (US)

(21) Appl. No.: 18/538,750

(22) Filed: Dec. 13, 2023

(51) Int. Cl. H04N 23/73; H04N 23/68; H04N 23/71; H04N 23/76; H04N 25/57

(52) U.S. Cl. CPC H04N 23/73; H04N 23/6811; H04N 23/71; H04N 23/76; H04N 25/57

(57) ABSTRACT

Methods, apparatuses, and computer-readable medium for incorporating motion awareness into the decision-making process of automatic exposure (AE) to prevent noticeable image quality deterioration resulting from motion blur. In some instances, by harnessing the capabilities of integrated camera Image Signal Processors (ISP), Inference Processing Unit (IPU), and/or Artificial Intelligent (AI) acceleration, the described methods, apparatuses, and computer-readable medium may achieve optimal computational efficiency and enhanced image quality.

### BACKGROUND

Conventional Automatic Exposure (AE) methods extensively rely on statistical data extracted from a single frame. This data encompasses the dark, mid, and bright points of the image, which are then compared against predefined target brightness values. Through this comparison, the methods calculate an optimal exposure value and proceed to adjust key sensor settings-namely, exposure time (shutter speed), analog gain, digital gain, and aperture value, as observed in compact and Digital Single-Lens Reflex (DSLR) cameras or in digital imaging systems that involve a fixed aperture (e.g., laptop, mobile phone, surveillance, and automotive cameras). The primary objective of this process is to attain an ideal exposure that faithfully reproduces critical elements within the captured scene, guided by specific design considerations.

The conventional AE methods require striking a balance between competing factors, such as signal-to-noise ratio (SNR), which relates to noise and detail preservation in shadow areas, and dynamic range, which pertains to sensor saturation. Additionally, in some instances the AE decision-making process incorporates additional variables like face brightness, backlight compensation, and scene characteristics. Despite these efforts, the impact of pronounced motion blur often surpasses the benefits gained from extended exposure duration. Conventional AE methods commonly adhere to preset exposure limits, irrespective of the degree of motion present in the scene. However, this approach may lead to suboptimal outcomes in certain scenarios. For instance, shorter exposure times for static scenes can result in increased noise, while extended exposures in motion-heavy scenes may introduce motion blur and ghosting artifacts.

### BRIEF DESCRIPTION OF THE DRAWINGS

A more detailed understanding can be obtained from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional details;

FIG. 3 is a block diagram of an example image-capturing device;

FIG. 4A is a block diagram of a conventional camera architecture;

FIG. 4B is a flow diagram of a typical Image Signal Processor (ISP) data processing pipeline;

FIG. 5 is a block diagram of an example camera architecture;

FIG. 6 is a flow diagram of an example motion-aware Automatic Exposure (AE) method; and

FIG. 7 is a flow diagram of an example method of adjusting the parameters of an image sensor.

### DETAILED DESCRIPTION

Aspects of the described methods, apparatuses, and computer-readable medium incorporate motion awareness into the decision-making process of automatic exposure (AE) to prevent noticeable image quality deterioration resulting from motion blur. In some instances, by harnessing the capabilities of integrated camera Image Signal Processors (ISP), Inference Processing Unit (IPU), and/or Artificial Intelligent (AI) acceleration, the described methods, apparatuses, and computer-readable medium achieve optimal computational efficiency and enhanced image quality. These improvements are particularly useful for delivering a better video conferencing experience using laptop cameras.

Other aspects of the described methods, apparatuses, and computer-readable medium incorporate the AE method, which analyzes the degree of motion in images to maximize the captured information while completely avoiding or greatly minimizing motion blur and ghosting artifacts depending on the scene characteristics, lighting conditions, and user/tuning preferences.

Image Signal Processors (ISPs) are a component in digital image systems that play a significant role in capturing and processing images or videos from the camera's image sensor. The ISP is responsible for various tasks that in some instances include noise reduction, color correction, white balance adjustment, sharpening, and more, all of which contribute to producing high-quality images and videos.

ISP parameters refer to the various settings, configurations, and controls that can be adjusted within the ISP to customize the way images and videos are processed. Common ISP parameters include:

White balance parameters ensure that the colors in an image appear accurate and natural under different lighting conditions. The user can select preset modes (such as daylight, cloudy, tungsten, etc.) or manually adjust the color temperature to suit the scene and to override or adjust automatically calculated parameters.

Exposure compensation parameters are used to adjust the exposure level or the overall brightness of an image. Increasing exposure compensation makes the image brighter, while decreasing it makes the image darker.

Noise reduction parameters control the amount of noise filtering applied to the image. Users can adjust these settings to find a balance between reducing noise and preserving image details.

Sharpening parameters control the degree of sharpness applied to the image. Users can adjust this to enhance details and edges and improve overall image clarity by increasing the local contrast.

Contrast and saturation parameters control the level of global contrast and color saturation in the image. Users can increase or decrease these settings to achieve a more vivid or neutral look.

Color correction parameters allow users to adjust the color balance and hue to correct color inaccuracies in the image.

Gamma correction parameters control the encoding and decoding of the pixel values. Adjusting this parameter can impact the overall tonal distribution and brightness of the image.

Lens correction parameters are used to mitigate geometric distortion, vignetting, and color shading effects.

The “3A algorithm suite” in digital imaging refers to a set of three core camera control algorithms (CCAs) that work together to automate and optimize certain key aspects of image capture. The 3A algorithms are typically employed in cameras and imaging systems to ensure that images are properly exposed, focused, and have accurate color balance. The three “A” s stand for Automatic Exposure (AE), Automatic White Balance (AWB), and Automatic Focus (AF).

Automatic focus is responsible for automatically adjusting the focus of the camera's lens to ensure that the subject is sharp and clear. Associated methods rely on contrast detection, phase detection, or their combination to quickly determine the correct focus distance, which is especially critical when dealing with moving subjects or varying distances between the camera and the subject.

Automatic white balance is an method that analyzes the color of the objects in the scene and adjusts the color balance of an image to make white and gray objects appear neutral and free from color casts in different lighting conditions (e.g., daylight, tungsten, fluorescent).

The final component of the 3A algorithm suite is automatic exposure, which refers to a camera's ability to automatically determine and set the appropriate exposure settings for capturing a well-balanced and properly exposed image. Exposure in photography refers to the amount of light that reaches the camera's image sensor over a period of time (a.k.a. exposure time) to create an image.

In the context of digital imaging, automatic exposure involves the camera's automated system analyzing the scene's lighting conditions. For example, the image brightness statistics are compared with the tuned target values to adjust the sensor settings for the best performance according to some contextual or perceptual criteria.

There is a complex interplay between automatic exposure, sensor saturation/clipping artifacts, image noise, and motion blur/ghosting artifacts. For instance, when there are moving subjects in a scene, their speed and direction of movement can impact the camera's exposure settings. Accordingly, if a subject is moving quickly, a shorter exposure time may be needed to freeze the motion and avoid blur, thus increasing the level of noise in the image. On the other hand, if the subject is static or moving slowly, a longer shutter speed might be an appropriate exposure for darker objects or regions of the scene, which may cause a certain portion of the image to saturate. If a subject moves from one area to an area with different lighting conditions, the camera's auto-exposure system needs to adjust the exposure settings to account for the changing light levels. Thus, in scenes with moving subjects and/or varying lighting conditions, accurately estimating the amount of motion and making real-time adjustments to exposure settings can help the camera's AE system adapt to changes in the scene and adjust the exposure settings to ensure that moving subjects are properly exposed and motion blur is controlled.

Together, the 3A algorithm suite attempts to ensure that images are properly exposed, focused, and color-balanced. However, achieving this goal is often challenging, especially in scenarios with changing lighting conditions, high dynamic range, fast moving objects, and the like.

Specifically, conventional AE methods used in the 3A algorithm suite attempt to minimize perceptually significant motion-based degradations by limiting the exposure time using the preset values regardless of the degree of motion in the scene.

For example, conventional AE methods widely rely on the image statistics collected from a single frame to compare the dark, mid, and bright points of the image against the corresponding tuned target brightness values to calculate the exposure value and subsequently adjust the sensor settings (capture parameters), such as the exposure time (shutter speed), analog gain, digital gain, and aperture value (in compact and DSLR cameras). The goal is to determine the best exposure for reproducing the most important regions of a given scene in the captured image according to some design criteria. In the parameter selection process, AE methods often aim at achieving a good dynamic range by making the desired tradeoffs among lowlight noise, saturated highlights, and motion blur, and/or considering some other factors, such as face brightness, backlight compensation, and scene type.

Due to the considerable impact of noticeable motion blur, the conventional AE methods often prioritize restraining exposure time by employing predefined values, regardless of motion intensity within the scene. Nevertheless, this approach can sometimes yield suboptimal outcomes. For instance, it may lead to increased noise in static scenes due to shorter exposures or introduce motion blur and ghosting artifacts in scenes with pronounced motion stemming from extended exposures.

In a bid to circumvent these challenges without introducing delays, advanced DSLR cameras employ specialized sensor components or pixels equipped with dedicated processing capabilities to estimate motion. This enables real-time adjustments to shutter, aperture, and ISO settings prior to capturing static images. Regrettably, due to factors such as design complexities and cost limitations, these features are not commonly feasible for PC sensors. As a result, alternative solutions are required, particularly tailored to the hardware and software architecture of laptop cameras.

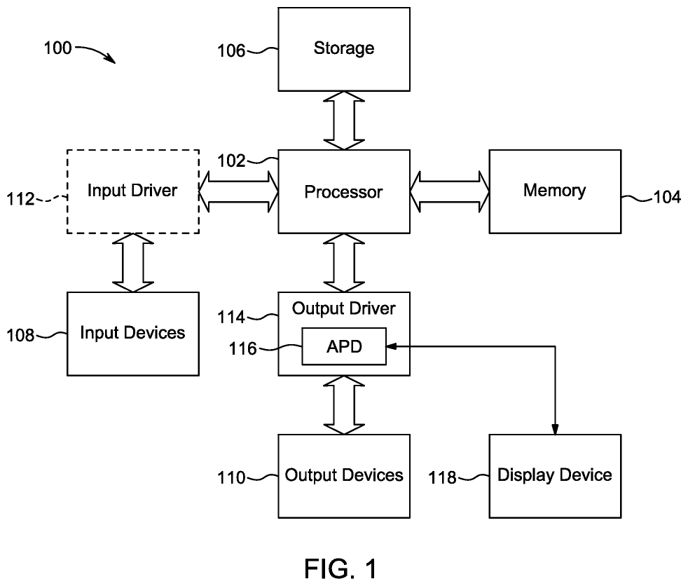

Elements of embodiments described in the present disclosure exploit the temporal and motion characteristics of streamed video to make more informative AE decisions using some form of motion awareness for each captured image frame. FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1. In one example, the device 100 is an image capturing device having a lens, for example, as the input device 108. Accordingly, hereinafter, the example device 100 may be referred to as image capturing device 100.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. In some instances, the output driver 114 manages an accelerated processing device (APD) 116 which is coupled to a display device 118. In some examples, the APD 116 is a graphics processing unit (GPU). The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (SIMD) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

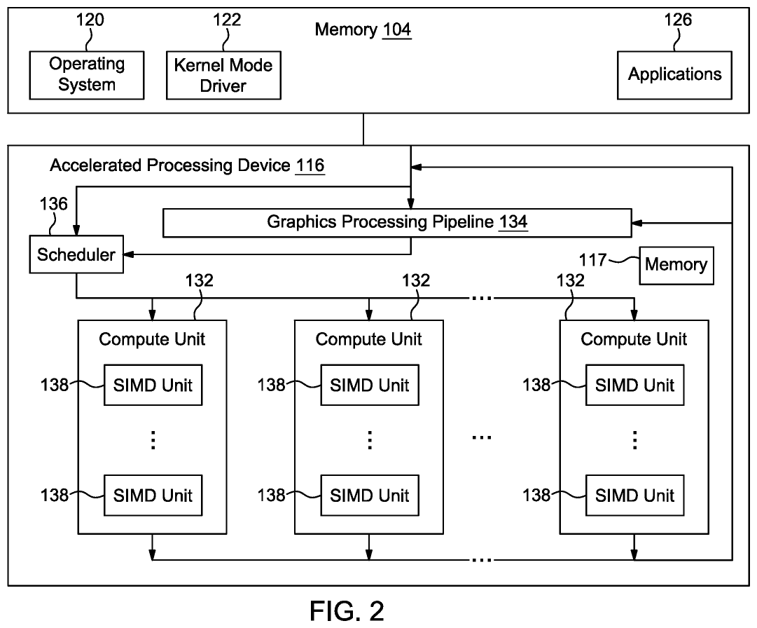

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls the operation of the APD 116 by, for example, providing an application programming interface (API) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes the compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The APD 116 also includes an APD memory 117 used by the compute units 132. The SIMD paradigm is one in which multiple processing elements share a single program control flow unit and program counter and thus execute the same program but with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts, which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for the operation of the graphics pipeline 134). An application 126 or other software executing on the processor 102 transmits programs that define such computation tasks to the APD 116 for execution.

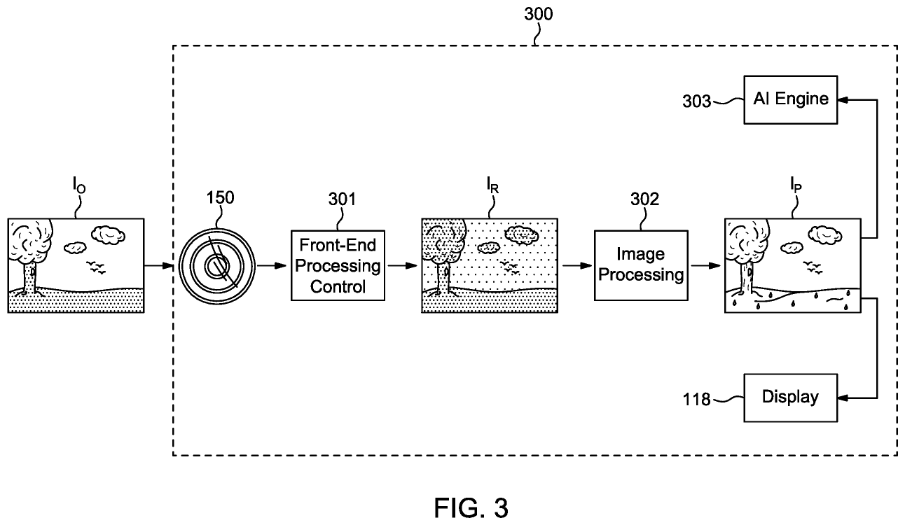

FIG. 3 is a block diagram of an example image capturing device 300 capturing and processing an image, according to an example. In some instances, the imaging device 300 includes the components described in FIG. 1. In addition, the image processing described below in the image capturing device 100, in some instances, is performed by the APD 116 or in the processor 102. The image capturing device 300 may include, for example, a lens 150, front-end processing control engine 301, an image processing engine 302, an artificial intelligence engine 303, and a display device 118.

The image capturing device 300 includes the sensor module with the lens 150 to capture an image scene Iₒ, which undergoes front-end processing control by the front-end processing engine 301 to generate a raw image IR. For example, in some instances, the front-end processing engine 301 controls an AF function, which utilizes the functionality of the imaging device 300 to automatically focus on a subject in the original image. In addition, other instances the front-end processing engine 301 controls an AE function, which sets one or more of an aperture, shutter speed, and other capture parameters or sensor settings of the image capturing device 300 based on the external lighting conditions. In some instances, the front-end processing engine 301 is implemented using APD 116

The obtained raw image is subject to image processing by the image processing engine 302. The image processing implements processing, such as demosaicing, shading correction, white balancing, color correction, gamma correction, and/or noise reduction. In some instances, image processing engine 302 is implemented using the APD 116.

Demosaicing is the process of creating a full color image from the mosaic-like image data captured by the sensor with the color filter array and the lens 150. Shading correction may be utilized to correct spatial non-uniformities, vignetting, and color shading effects. White balance is utilized to remove color casts and make achromatic objects appear neutral, while color correction may be utilized to make color as accurate with respect to the original scene or some reference target as possible. Noise reduction includes removing noise and outliers from an image to increase its information value.

Gamma correction may be utilized to adjust the luminance levels and/or the overall brightness of an image, since a sensor module (e.g., image sensor with the lens 150) of an image capturing device (e.g., image capturing device 100 or 300) may not capture an image in the same manner as a human eye. Thus, gamma correction may be utilized to adjust the image brightness to be more visually acceptable to the human eye.

Therefore, once the raw image has been processed by image processing engine 302, a processed image Iₚ is the resultant image. In some instances, the processed image is then be provided to the display device 118 for viewing by a user of the image capturing device 300. In other instances, the processed image is additionally or alternatively provided to an artificial intelligence (AI) engine 303. The AI engine 303 performs additional processing on the process image. For example, the AI engine can identify vehicles, faces or other objects contained in the processed image. In some instances, the AI engine 303 is implemented on the APD 116 and/or the processor 102.

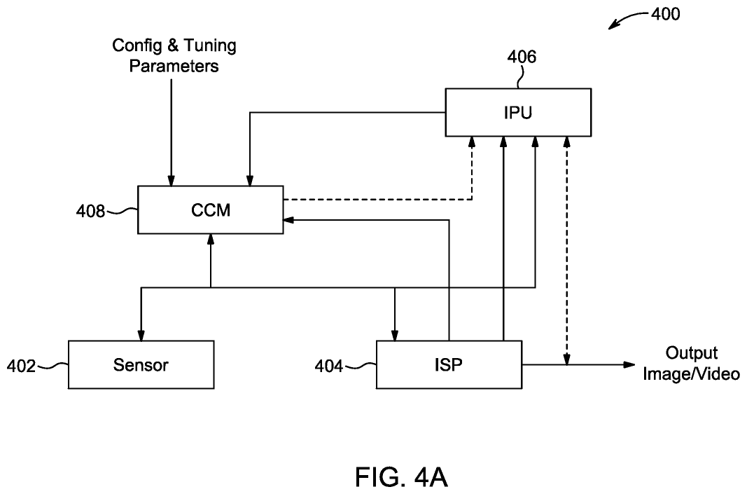

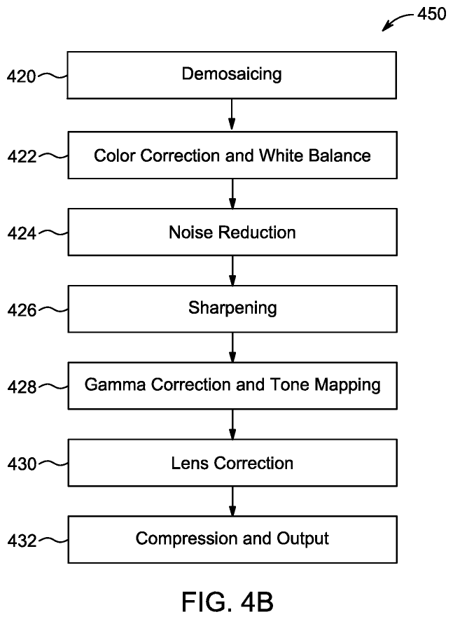

FIG. 4A shows a block diagram of a conventional camera architecture 400. Each raw image is captured by a sensor 402. The sensor 402 captures the raw image by converting the light incident on the sensor to an electrical signal. In some instances, the sensor is a CCD (Charge-Coupled Device) or a CMOS (Complementary Metal-Oxide Semiconductor) sensor. The sensor 402 may include lenses and mirrors that focus the incident light.

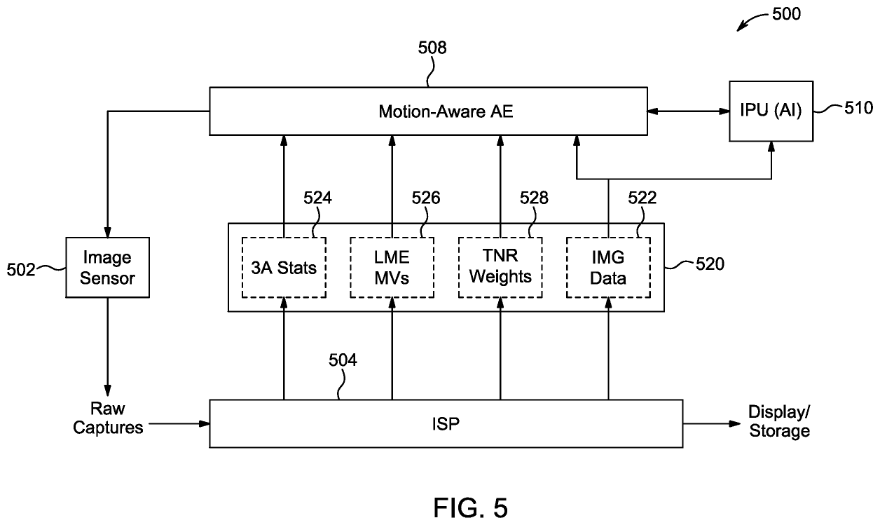

The raw image captured by the sensor 402 is fed to an ISP 404. In many instances, the ISP 404 utilizes hardware acceleration to implement the image processing pipeline (e.g., ISP pipeline 450 in FIG. 5, described later). In some instances, the ISP 404 may be implemented using a GPU, Image Processing Unit, Digital Signal Processor (DSP), or other specialized circuitry.

The ISP 404 may collect statistics, usually at some earlier stage of ISP pipeline, and share the statistics with the Camera Control Method (CCM) 408. In some instances, the CCM 408 may be implemented by camera software or firmware, using a Digital Signal Processor (DSP), or other specialized circuitry.

The statistics may provide insights into image characteristics, such as brightness, contrast, and color distribution of the captured image. The statistics may include at least one of a mean (average) brightness, block (grid) averages, counts of saturated pixels on a per image and/or block basis, image histograms (for luminance and/or color channels), and the like. In some cases, these statistics may be calculated for each color channel (e.g., red, green, and blue channels) and/or the luminance image obtained as a combination of the color channels.

The CCM 408 utilizes the 3A algorithm suite (i.e., AE, AF, and AWB). Specifically, the CCM 408 of the conventional camera architecture 400 uses the conventional AE method that relies on the image brightness target values and contextual/perceptual criteria to make optimal exposure decisions. Since the guiding statistics collected by the ISP 404 are usually collected and analyzed in a framewise manner, perceptually significant motion degradations are reduced by limiting the exposure time using the preset values. Thus, the conventional AE methods implemented by the CCM 408 fail to incorporate the degree of motion in the scene into the AE decision-making process, often resulting in noisier images of the static scenes taken with too short exposures or the presence of motion blur in images of the scenes with significant motion taken with too long exposures.

In some instances, the IPU 406 may receive the statistics from the ISP 404. Additionally, in some instances, the IPU 406 may receive information from the CCM 408 and/or the intermediate or output image from ISP 404. The IPU 406 may use trained artificial intelligence (AI) models to perform face detection, scene detection (e.g., indoor, outdoor, backlight, lowlight) to assist or guide at least some of CCM and/or ISP methods. In some scenarios, the IPU 406 may perform image postprocessing to enhance the image quality of output ISP images using denoising, super-resolution enhancement, lighting correction, and the like. In yet other scenarios, the IPU 406 may create special effects, such as background blur, user framing, eye contact correction, user beautification, and the like, to further enhance user experience.

FIG. 4B illustrates a typical ISP pipeline 450 that may be implemented by the ISP 404. The ISP processing pipeline typically consists of several key stages, each performing specific tasks to improve the overall image quality.

For example, in step 420, the ISP may receive the image data in mosaic format, such as Bayer color filter array format, to perform demosaicing. The mosaic format implies that each pixel captures only one color component (red, green, or blue), and thus, such an image must be subject to demosaicing to interpolate two missing color components in each pixel location to create a full-color image.

Then, in step 422, the ISP may perform white balancing and color correction. White balancing ensures that white (and gray) objects appear neutral regardless of the lighting conditions, while color correction is used to produce accurate and natural colors in the image.

In step 424, the ISP may perform noise reduction to reduce noise in the image, which may be introduced during the image capture process, especially in low-light conditions. Various noise reduction techniques, such as spatial filtering (e.g., Gaussian, bilateral, non-local means, and guided filters) and temporal noise reduction, can be applied to improve image clarity and suppress luminance noise and color noise.

In step 426, the ISP may perform sharpening to enhance edges and details in the image, making it appear crisper and more defined. This stage increases the perceived sharpness of the image by enhancing contrast along the edges.

In step 428, the ISP may perform gamma correction and tone mapping. Gamma correction adjusts the tonal relationship between the input data and the displayed image to ensure that the image appears correctly on various display devices. Tone mapping helps adjust the contrast of the image to ensure details are visible in both shadow and highlight areas.

Next, in step 430, the ISP may perform lens correction to address geometric distortion, vignetting, and other optical imperfections caused by the camera lens.

Finally, in step 432, the ISP applies compression to efficiently represent the output image for storage or transmission. Once the image has been processed, it may be compressed into a final image format (e.g., JPEG) suitable for storage, subsequent processing, or display.

FIG. 5 shows a camera architecture 500 in accordance with an embodiment. The sensor 502 captures the raw image by converting the light incident on the sensor to an electrical signal. In some instances, the sensor is a CCD (Charge-Coupled Device) or CMOS (Complementary Metal-Oxide Semiconductor) sensor. The sensor 502 may include lenses and mirrors that focus the incident light.

The raw image captured by the sensor 502 is fed to an ISP 504. In many instances, the ISP 504 utilizes hardware acceleration to implement the image processing pipeline (e.g., ISP pipeline 450). In some instances, the ISP 504 may be implemented using a GPU (e.g., the APD 116), Image Processing Unit, Digital Signal Processor (DSP), or other specialized circuitry.

The ISP 504 may provide information 520 on the raw image and/or the results of the processing of the raw image by the ISP pipeline to the Motion Aware Camera Control Unit (MACCU) 508. In some instances, the MACCU 508 may be implemented using a GPU (e.g., the APD 116), ISP, IPU, Image Processing Unit, DSP, or other specialized circuitry.

The information 520 may comprise image data 522, 3A statistics 524, motion vectors (MVs) 526, and/or frame mixing weights 528, and the like.

In some instances, image data 522 may be the raw image received from the sensor 502. In other instances, the image data may include the output image from the ISP 504 or some intermediate result by the ISP 504.

The image data 522 may also be a color filter array (CFA) image, full color image, or grayscale image (e.g., a weighted combination of channels from a color or CFA image, or a native output by a monochromatic sensor). The image data 522 may be utilized by the MACCU 508 to discriminate between optical and motion blur and in-focus areas.

The image data 522 may also be a subtracted image (i.e., the difference between the two consecutive frames). The subtracted image may be utilized by the MACCU 508 to discriminate between noise and motion.

In some instances, the image data 522 may include a multichannel image comprised of the actual image/frame and the frame difference data (e.g., luminance image & subtracted luminance image, color image & subtracted luminance image, color image & subtracted color frame, or any other suitable combination). The subtracted image refers to the difference between two images, such as consecutive frames, frames selected based on some predetermined criteria, and the like.

The 3A statistics 524 may include at least one of a mean (average) brightness, block (grid) averages, counts of saturated pixels, image histograms, and the like. In some instances, these statistics are collected for each color channel and/or the luminance image.

In some instances, the motion vectors (MVs) 526 are generated by the ISP 504 using local motion estimation (LME) to support multi-frame processing. The LME methods are used in digital image and video processing to analyze and estimate motion within specific regions or patches of an image or video frame. Instead of considering motion for the entire frame as a whole, LME focuses on smaller, localized regions to provide more accurate and detailed motion information. In some instances, the LME method may be implemented in the ISP 404, DSP, GPU, or other suitable circuitry and/or in camera software or firmware.

In some instances, the motion vectors (MVs) 526 are converted into a motion and/or confidence map using soft thresholding or some other suitable conversion function. For example, the motion map can be created by normalizing the magnitude (or length) of motion vectors between 0 and 1. In another example, the magnitude of motion vectors is passed through a nonlinear transfer function, such as an exponential function or other suitable mathematical function, to obtain the motion map. In yet another example, the conversion can be achieved using a piecewise linear function, lookup table, and the like.

The frame mixing weights 528 may be a result of a temporal noise reduction (TNR), which is a digital image and video processing technique used to reduce image noise and temporal oscillations while preserving the image details and structures by averaging consecutive frames together. This process is guided by the weights, which are determined based on the similarity of corresponding blocks or regions (e.g., blocks from the same image location, or blocks identified using motion compensation, image registration, and the like) in the previous and actual frame. In some instances, the frame mixing weights 528 may represent the weights used to combine two reference images or frames other than two consecutive frames from the streamed video.

In other instances, the frame mixing weights 528, the subtracted frame obtained using the image data 522, and/or motion/confidence maps created by transforming motion vectors 526, subtracted frames, subtracted 3A statistics, and the like into the desired map format are subject to enhancement to suppress noise and small structures and make the map data more consistent. Suitable enhancement techniques include low-pass filtering (e.g., mean, Gaussian, weighted-average, and median filters), morphological filters, power (e.g., gamma) functions, and the like.

The MACCU 508 receives the information 520 and implements a camera control method that utilizes an automatic exposure (AE) method (e.g., AE method 600), which analyzes the degree of motion in images to maximize the captured information. The MACCU 508 utilizes the information 520 to overcome the limitations of conventional CCAs that do not consider the degree of motion in the image. For example, in many instances, the MACCU 508 can completely avoid or greatly minimize motion blur and ghosting artifacts depending on the scene characteristics, lighting conditions, and user/tuning preferences.

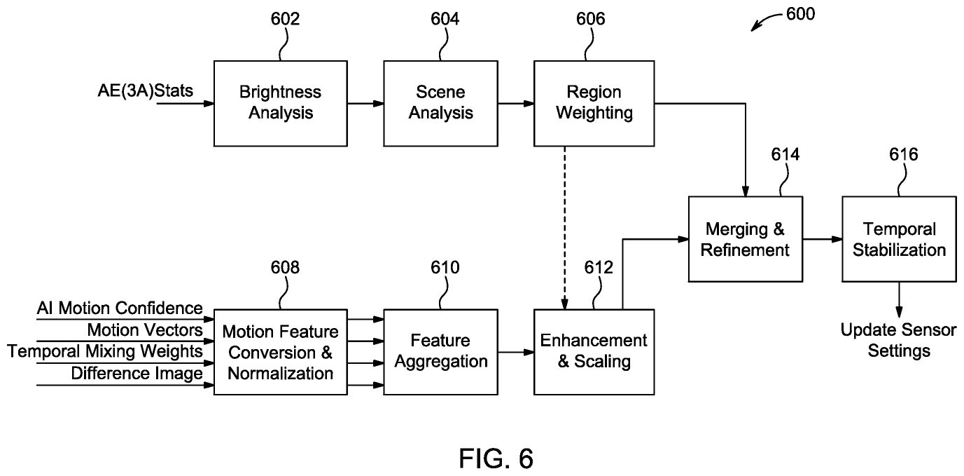

In some instances, the degree of motion in the image is determined using one or more motion or confidence maps, which may be subject to feature conversion and normalization, aggregation, region weighting, enhancement, scaling, and the like, to extract key motion statistics as will be discussed later in relation to FIG. 6. The map values and/or extracted key statistics represent the degree of the motion expressed in their respective signal ranges. For instance, for the normalized motion or confidence map ranging from 0 (no motion) to 1 (maximum motion), the map pixel value 0.20 indicates 20% strength or degree of motion in the scene (i.e., relatively small motion in this case). In other instances, the degree of motion is determined by scaling (dividing) the motion feature value with the maximum theoretical value for a given feature or some predetermined or otherwise suitable value. Thus, the motion features, confidence map values, key statistics, and the like provide crucial measurable information about the scene motion that is then leveraged in the AE decision-making process.

In some instances, the IPU 510, or some other software or hardware module capable of performing artificial intelligence (AI) inference, may receive the information 520 from the ISP 504. Additionally, in some instances, the IPU 510 may receive information from the MACCU 508. The IPU 510 may perform face detection, denoising, or some other image processing and analysis operations to further enhance the image quality and user experience using trained AI models. The AI models can also be trained to perform foreground-background decomposition, background removal, and detect/track faces and other objects to help estimate the motion blur in videoconference use cases based on face sharpness and location changes, etc. The IPU 510 may generate one or more motion maps with a confidence value per input pixel or a block of input pixels, and/or an overall motion confidence score based on the information 520. In some instances, the IPU may also use the actual settings of the sensor 502 to estimate the degree of motion and update these settings. The processes implemented by IPU 510 may further involve various AI internal operations, such as data conversion and normalization, resizing, inference, and/or postprocessing.

FIG. 6 illustrates an example of motion-aware AE method 600 that may be utilized by MACCU 508. In many instances, the AE method 600 can differentiate between scene changes due to local motion, camera movement, and significant shifts in lighting conditions.

The AE method 600 may include a brightness analysis 602 that receives the 3A statistics (e.g., 3A statistics 524). The brightness analysis 602 involves assessing the overall luminance or brightness level of an image or scene based on the 3A statistics. For example, the brightness statistics, such as the dark, mid, and bright points of the image, are compared against the corresponding tuned target brightness values. In another example, the face brightness is compared with the target face brightness value. In yet another example, face brightness is combined with other scene brightness statistics for the best exposure trade-offs between foreground (face) and background (scene).

The AE method 600 may also include a scene analysis 604. The scene analysis 604 considers the scene's brightness, contrast, sharpness, and color temperature based on the 3A statistics or some other downscaled version of the captured image. In some instances, the scene analysis also considers the results of the brightness analysis 602. For example, the brightness analysis result or the corresponding brightness statistics, including face brightness, can be used to determine if the actual scene is a backlight, low-light, low-key, or high-key scene. On the other hand, the color temperature can help differentiate between outdoor and indoor scenes. In some other instances, the scene detection can be performed using trained AI models, semantic image analysis, and the like.

In some instances, region weighting 606 also is included in AE method 600. Region weighting 606 assigns different levels of importance or priority to specific regions or areas within an image by putting more weight on face, central regions, and some other regions of interest. Thus, region weighting 606 may be driven by the face presence, manual region selection via screen touch, metering pattern, focus point, object size, distance from the center, etc., to emphasize areas that contribute more to a visually pleasing image. In some instances, the region weighting 606 is performed based on the results of the brightness analysis 602 and/or the scene analysis 604.

The AE method 600, in some instances, also performs motion feature conversion and normalization 608. This block receives motion information in the form of image data 522, 3A statistics 524, motion vectors 526, frame mixing weights 528, and the like. Since each feature may use its own unique data format and range, the input motion information needs to be converted into the desired format and normalized prior to feature aggregation 610. In one instance, the motion vectors 526 are converted into a motion map using soft thresholding or some other suitable conversion function (e.g., exponential) to normalize the magnitude (length) of motion vectors between 0 and 1. In another instance, the conversion can be achieved using a piecewise linear function, lookup table, and the like to approximate more complex conversion functions. The data conversion/normalization techniques are applicable to various input features unless they are already in the desired format for feature aggregation 610.

In the context of artificial intelligence (AI) and machine learning (ML). features are individual, measurable properties or attributes used to represent an observation or data point. They serve as the input variables that an AI method uses to make decisions, predictions, or classifications. For example, in computer vision, features might include edges, corners, textures, or more complex structures like SIFT (Scale-Invariant Feature Transform) or SURF (Speeded-Up Robust Features) descriptors. In many instances, features can also be automatically extracted or learned by the model itself, as seen in techniques like deep learning. Here, the initial layers of a neural network might automatically learn to identify useful features from raw data, which are then used by subsequent layers to make decisions or predictions.

In some instances, each of the motion feature is also subject to enhancement to suppress noise and small structures, and further modulate or otherwise adjust the motion maps. Suitable enhancement techniques include low-pass filtering (e.g., mean, Gaussian, weighted-average, and median filters), morphological filters, power (e.g., gamma) functions, and the like.

In some instances, the motion feature conversion and normalization 608 also receives an AI motion confidence. For example, the AI motion confidence may be received from IPU 510 as the response of at least one trained AI model on the information 520 collected for motion analysis. The AI motion confidence may have the form of one or more motion maps with a confidence value per input pixel or a block of input pixels, and/or represent the overall motion confidence score (equivalent to setting all pixels in a motion map to the overall motion confidence score value) based on the information 520.

The results of the motion feature conversion and normalization 608 are then subject to feature aggregation 610, which combines multiple inputs into a single motion map according to some predefined criteria or tuning preferences. In some instances, the features may be combined using weighted averaging or some other suitable operation.

The single combined motion map generated by feature aggregation 610 then undergoes enhancement and scaling 612. Specifically, in some instances, the combined motion map is subject to enhancement through filtering, such as weighting averaging, median, and/or morphological filtering. In some instances, the combined motion map undergoes scaling based on the results of the brightness analysis 602, the results of the scene analysis 604, and/or the results of the region weighting 606. In addition, in some instances, the combined motion map is subject to region weighting based on the results of the region weighting 606.

The results of the enhancement and scaling 612 are then received by merging and refining 614. In merging and refining 614, a motion map, individual blocks, or the region(s) of interest are then represented by key statistics. For instance, the key statistics may include cumulative histogram (e.g., for 5, 10, 20, 50, 80, 90, and 95 percentiles), histogram peaks, median and maximum values, averages of several largest (e.g., top 10%) motion map or motion confidence values, or performing some other numerical analysis to understand the nature of scene changes. In some instances, the key statistics are then compared with the predetermined threshold(s) and/or undergo further analysis to determine the degree of motion in the scene.

If the extracted statistics indicate significant motion (e.g., the statistics greater than the predetermined value, such as 50% of allowable range) in one or more of the regions of interest, the merging and refining 614 will generate an output for AE method 600 that indicates the exposure time will be reduced according to the tuning preferences in favor of higher noise implied through shorter exposure and possibly higher analog gain to compensate for brightness loss. Otherwise (in situations with negligible motion), the merging and refining 614 generates an output for AE method 600 that is consistent with conventional AE methods. In some instances, the merging and refining 614 generates an output for AE method 600 that indicates the degree of motion in the scene. In some instances, merging and refining 614 allows for the use of the longer exposure time to improve SNR while avoiding objectionable motion blur. In some other instances, the exposure time is scaled with the key statistics, calculated as a function of the degree of motion, subject to adaptive/dynamic mapping or other suitable transformation driven by extracted motion information.

As a result, unlike in conventional AE methods, where the guiding statistics are usually collected and analyzed in a framewise manner, the AE method 600 leverages temporal and motion characteristics extracted from multiple frames. Thus, AE method 600 overcomes the failure of conventional AE methods to incorporate the degree of motion in the scene into the AE decision-making process and to avoid producing inaccurate exposure settings. Moreover, in some instances, the motion analysis results and/or the output of the merging and refining 614 obtained for several frames are combined (e.g., the weighted average of the results obtained for the past frame and the current frame) to further stabilize or enhance the performance of the AE method 600.

For instance, since AE estimates are often prone to temporal oscillations due to noise, scene changes, and various processing errors, in some instances, the AE method 600 utilizes temporal stabilization 616. This step may leverage stabilization strategies, such as temporal filtering of AE estimates to suppress oscillations and dead zones to lock capture parameters until a significant scene change occurs. The temporal stabilization 616 is tunable to achieve the desired convergence and stability of output of the AE method 600.

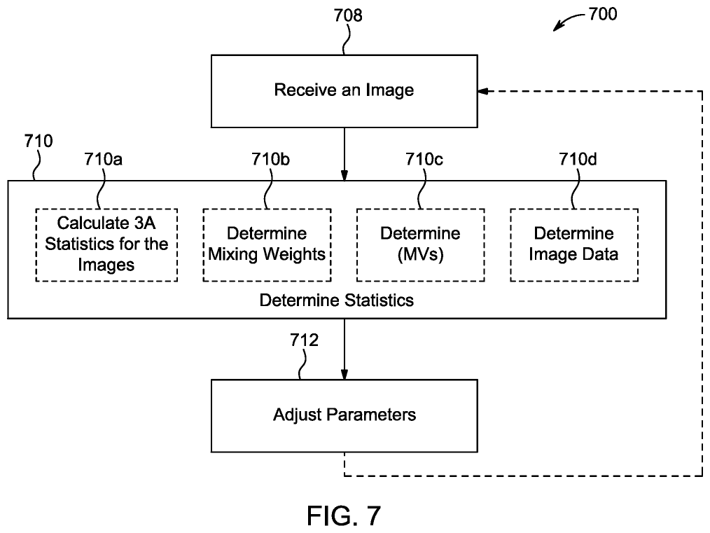

FIG. 7 is a flow diagram of an example of a method 700 of adjusting parameters of an image sensor, according to an example. Method 700 introduces motion awareness into the AE decision-making to avoid perceptually significant degradations in captured images caused by the motion blur. Method 700 is practical and well-aligned with camera architectures and data processing flows.

In step 708, at least one captured image is received. In some instances, this includes receiving the current frame from an image sensor (e.g., sensor 502) and retrieving the previous image data from memory or storage. In some instances, the previous image data is one or more previous frames and/or the corresponding information 512.

In step 710, the motion features, image data, and statistics for motion analysis are collected (e.g., information 520). In some instances, step 710 includes calculating 3A statistics (e.g., 3A statistics 524) in 710a, determining the mixing weights between the current frame and the previous frame in 710b, obtaining the motion vectors (e.g., motion vectors 526) in 710c. In some instances, step 710 includes determining the data (e.g., image data 522) in 710d, for instance, as the difference between the current frame and the previous frame.

Next, in step 712, one or more of the parameters of the image sensor (e.g., sensor 502) are adjusted based on the statistics determined in 710. The one or more parameters of the image sensor that are adjusted may include at least one of the exposure settings (e.g., shutter speed, aperture control, analog gain, digital gain, or integration time), focus settings (e.g., focus mode or focus point/zone), white balance, metering mode, exposure compensation, drive mode, flash settings, focal length, zoom, noise reduction settings, image stabilization, or any similar configurable parameters of the sensor.

For example, in step 712, one or more of the parameters of the image sensor may be performed in accordance with AE method 600 based on the statistics and motion features determined in step 710. In some instances, the exposure time is reduced by the amount determined as the maximum allowed exposure time change (e.g., 80% of the actual exposure time) further adjusted based on the determined degree of motion (e.g., 50% motion), resulting in a shorter new exposure time (e.g., 10−10*0.8*0.5=6 ms instead of original 10 ms in the above example). In some other instances, the exposure time is adjusted both ways (i.e., reduced for larger motion and increased for negligible motion), subject to noise and saturation constraints. Alternatively, the new exposure time is obtained using a lookup table (e.g., 2D table defined by key combinations of the degree of motion and the initial exposure time). In some other instances, the change in exposure time is accompanied with the updates to other sensor and/or image capture settings, such as analog and digital gain values, to reach the target scene/face brightness and/or meet some other predetermined AE criteria, such as dynamic range, noise, and saturation.

In some instances, the AE method 600 involves one or more trained AI models to produce at least one motion and/or confidence map or the overall motion confidence or some other value indicating the degree of motion in the scene. Training an AI model involves a process where the model learns from a dataset, adjusting its internal parameters to minimize the difference between its predictions and the actual outcomes. The aim is to enable the model to generalize well to new, unseen data.

The process of training an AI model begins with collecting a dataset that is relevant to the problem at hand, ensuring that the data is both high-quality and sufficient in quantity. Once the data is collected, preprocessing steps are necessary to clean and transform the data into a useful format. This includes handling missing values, normalizing numerical features, and encoding categorical variables. Often, feature engineering is performed to create new attributes that better represent the underlying problem. The dataset is then usually divided into two or more subsets: a training set for building the model, a test set for evaluating its performance, and sometimes a validation set for tuning hyperparameters.

Choosing the appropriate method or architecture for the problem is the next crucial step, whether that is a classical machine learning model like a decision tree or a more complex neural network in the case of deep learning. The model is trained on the training dataset, making predictions and adjusting its internal parameters to minimize the “loss,” or the difference between its predictions and the actual outcomes. This adjustment is commonly done using optimization methods like gradient descent. After training, the model is evaluated using the test set, with performance metrics varying depending on the type of problem (e.g., accuracy, F1 score, “Area Under the Curve” of the “Receiver Operating Characteristic” (AUC-ROC)). Hyperparameter tuning may also be performed based on the validation set, and this process can be iterative. Once finalized, the model is deployed into a production environment, where it starts processing new data to make real-time decisions or predictions. Ongoing monitoring and updating are essential as data distributions and conditions change over time, which may necessitate retraining the model.

In the case of the AE method 600, in some instances, the AI model is trained with the reference images and their adjusted versions obtained using at least one desired degradation function to approximate motion blur, optical blur, noise, and other types of image degradations. In some other instances, the training dataset consists of labelled real-life image and video captures, with the labels marking the type and the severity of target image degradations. Alternatively, the training data can be captured in the environments with controlled lighting, scene content, and object movement. Such data can be used to train AI models to generate motion features or motion/confidence maps, to estimate the degree of motion in the scene, and/or to produce the optimal sensor and image capture settings based on some predetermined criteria or trade-offs between motion blur, highlight saturation, noise, and/or dynamic range.

In addition, in some instances, in step 712, one or more of the ISP parameters are also adjusted based on the statistics determined in 710.

Optionally, the parameters adjusted in 712 are then utilized to acquire at least one new image or frame, and method 700 is repeated.

Method 700 overcomes design drawbacks of conventional control methods and may take advantage of both low latency and high compute power of ISP and IPU available on system-on-chip (SoC) architectures.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the APD 116, the scheduler 136, the compute units 132, the SIMD units 138, Front-End Processing Control 301, Image Processing 302, AI Engine 303, ISP 504, and IPU 510 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general-purpose computer, a processor, or a processor core. Suitable processors include, by way of example, a general-purpose processor, a special-purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media, such as CD-ROM disks and digital versatile disks (DVDs).

What is claimed is:

1. A method for adjusting parameters of an image sensor, the method comprising:
receiving an image of a scene;
obtaining statistics for the image based on at least one image;
determining a degree of motion in the scene based on the statistics obtained for the image; and
adjusting, automatically, exposure of the image sensor based on the degree of the motion in the scene determined for the image.

2. The method of claim 1, wherein the statistics for the image include at least one of motion vectors, frame mixing weights, or image data.

3. The method of claim 2, wherein the statistics include the frame mixing weights and the frame mixing weights are a result of a temporal noise reduction or averaging at least two images or frames together based on similarities of the at least two images or frames.

4. The method of claim 2, wherein the statistics include the motion vectors and the motion vectors are a result of local motion estimation or image registration.

5. The method of claim 2, wherein the statistics include the image data and the image data includes one or more of 3A statistics, a raw image, an intermediate image, a final output image, or a subtracted image.

6. The method of claim 1, wherein the determining the degree of the motion in the scene is performed using at least one trained model for one or more of the statistics obtained.

7. The method of claim 1 wherein the determining the degree of the motion in the scene is performed using at least one conversion function for one or more of the statistics.

8. The method of claim 1 wherein the adjusting of the exposure of the image sensor is performed using one or more of a motion feature conversion and normalization, feature aggregation, motion map enhancement and scaling, brightness and scene analysis, region weighting, or temporal stabilization.

9. The method of claim 1, wherein the determining the degree of the motion in the scene is performed using a motion map or a confidence map,
wherein the motion map includes at least one of a motion or confidence value per input pixel, a block of input pixels, or an overall motion or confidence score per image.

10. The method of claim 1, wherein the adjusting the parameters of the image sensor is performed by a trained model.

11. A system for adjusting parameters of an image sensor, the system comprising:
a memory, and
a processor that is communicatively coupled to the image sensor and the memory,
wherein the processor is configured to:
receive an image of a scene,
obtain statistics for the image based on at least one image,
determine a degree of motion in the scene based on the statistics obtained for the image,
adjust, automatically, exposure of the image sensor based on the degree of the motion in the scene determined for the image.

12. The system of claim 11, wherein the statistics for the image include at least one of motion vectors, frame mixing weights, or image data.

13. The system of claim 12, wherein the statistics include the frame mixing weights and the frame mixing weights are a result of a temporal noise reduction or averaging at least two images or frames together based on similarities of the at least two images or frames.

14. The system of claim 12, wherein the statistics include the motion vectors and the motion vectors are a result of local motion estimation or image registration.

15. The system of claim 12, wherein the statistics include the image data and the image data includes one or more of 3A statistics, a raw image, an intermediate image, a final output image, or a subtracted image.

16. The system of claim 11, wherein the degree of the motion in the scene is determined using at least one trained model for one or more of the statistics obtained.

17. The system of claim 11 wherein the degree of the motion in the scene is determined using at least one conversion function for one or more of the statistics.

18. The system of claim 11 wherein the exposure of the image sensor is adjusted using one or more of a motion feature conversion and normalization, feature aggregation, motion map enhancement and scaling, brightness and scene analysis, region weighting, or temporal stabilization.

19. The system of claim 11, wherein the degree of the motion in the scene is determined using a motion map or a confidence map,
wherein the motion map includes at least one of a motion or confidence value per input pixel, a block of input pixels, or an overall motion or confidence score per image.

20. A non-transitory computer readable storage medium storing instructions for adjusting parameters of an image sensor, the instructions when executed by a processor cause the processor to execute a method comprising:
receiving an image of a scene,
obtaining statistics for the image based on at least one image,
determining a degree of motion in the scene based on the statistics obtained for the image,
adjusting, automatically, exposure of the image sensor based on the degree of the motion in the scene determined for the image.
